(19) United States
(12) Patent Application Publication
(10) Pub. No.: US 2024/0369405 A1
(43) Pub. Date: Nov. 7, 2024

(54) OPTICAL PROBE FOR MEASURING PHOTON DENSITY

(71) Applicant: TOMPHYZX. LLC, Dundee, NY (US)

(72) Inventor: Thomas Dunbar, Dundee, NY (US)

(21) Appl. No.: 18/654,971

(22) Filed: May 3, 2024

Related U.S. Application Data
(60) Provisional application No. 63/463,624, filed on May 3, 2023.
(60) Provisional application No. 63/472,714, filed on Jun. 13, 2023.

(51) Int. Cl. G01J 1/04; G01J 1/44

(52) U.S. Cl. CPC G01J 1/0437; G01J 1/0422; G01J 1/44

(57) ABSTRACT

An apparatus for measuring photon density, the apparatus comprising a substrate having a volume for receiving photons from within an optical radiation field, the substrate having an outer periphery, an inner periphery, and an exit aperture, a first reflecting layer coating at least a portion of the outer periphery of the substrate, the first reflective layer configured to integrate the photons within the volume of the substrate, a plurality of entrance openings within the first reflective layer for diffracting the photons entering the volume and a photon detector configured to receive the photons to detect a photon density and to produce an electrical signal representative of the detected photon density, wherein the substrate having the coating is configured such that the photons incident on the exit aperture of the volume of the substrate are at least substantially equally proportional to the photons incident on the plurality of entrance openings.

### CROSS REFERENCE TO RELATED APPLICATIONS

This application claims the benefit of U.S. Provisional Application No. 63/463,624 filed on May 3, 2023 and U.S. Provisional Application No. 63/472,714 filed on Jun. 13, 2023, each of which is hereby incorporated by reference.

### BACKGROUND OF THE INVENTION

### Field of the Invention

This invention relates generally to optical testing and more particularly to a photon density measuring apparatus and method.

### Description of Related Art

It is currently understood that the principal transmission method for the coronavirus is as an inhaled aerosol. Thus, research is underway to determine the best method for aerosol viral inactivation using UV-C light. Unfortunately, most of the research focuses on using UV-C exposure of viral particles contained on the surface of petri dishes and results are evaluated with Irradiance values measured in units of

$$\frac{W}{{cm}^{2}}$$

combined with the experiment duration yielding exposure values in units of

$$\frac{J}{{cm}^{2}} .$$

However, surface based experiments are not suitable for evaluating inactivation characteristics for aerosolized situations.

Moreover, in some pathogen reduction systems, 253.7 nm wavelength mercury vapor amalgam lamps are used for inactivation. The principal inactivation at this wavelength in RNA based pathogens is absorption of photons into the uracil base within the RNA structure. In the process a photon is absorbed in uracil C₄H₄N₂O₂ creating an excited state (π*). This reacts with a rest state uracil (π) forming an uracil dimer C₈H₈N₂O₄ which disrupts the transcription process preventing replication (inactivated). The timing of the photo-chemical reaction is a 10-15 second photon absorption causing an increase in the internuclear oscillation in 10⁻¹² seconds which is necessary for the dimer formation reaction. If the reaction does not occur given proximity of rest state uracil bases, the π*bases relax within 10⁻³ seconds. The probability of inactivation is directly related to the population percentages of excited and rest state bases during a 1 millisecond convolution over the time a pathogen is within a device active region, and the goal is a population inversion. Only the parallel component of the photon electric field vector relative to the uracil dipole transition moment contributes to the probability of absorption. Thus, the best attack orientation is for the photon electric field vector to be parallel to the dipole axis and the photon Poynting vector to be perpendicular. Given the random nature of bases within the RNA or DNA structure and the preferential orientation for probability of absorption, attacking a viral particle from a large percentage of possible attack angles simultaneously is preferred. Most UV-C inactivation systems attack from a singular or low number of angles such as the traditional “upper air” UV systems. It is helpful to determine the corresponding optical power density that is independent of angle attack within a pathogen reduction device, which is sometimes referred to as photon density. Thus, a device that measures photon density in a pathogen reduction device is desired. Using a traditional “flat” detector is not possible for this purpose since the detector response is a function of the angle between the detector normal and the Poynting vectors of photons within a volume.

### BRIEF SUMMARY OF THE INVENTION

A first exemplary embodiment of the present invention provides an apparatus for measuring photon density (mW/cm³) within a medium. The apparatus includes a substrate having a volume for receiving photons from within an optical radiation field (J/cm³), the substrate having (i) an outer periphery; (ii) an inner periphery; and (iii) an exit aperture. The apparatus further includes a first reflecting layer coating at least a portion of the outer periphery of the substrate, the first reflective layer configured to integrate the photons within the volume of the substrate. Additionally, a plurality of entrance openings within the first reflective layer for diffracting the photons entering the volume. The embodiment further includes a photon detector configured to receive the photons to detect a photon density and to produce an electrical signal representative of the detected photon density, wherein the substrate having the coating is configured such that the photons incident on the exit aperture of the volume of the substrate are at least substantially equally proportional to the photons incident on the plurality of entrance openings.

A second exemplary embodiment includes a method of making a device for measuring photon density (mW/cm³) within an E-M field from a photon source. The method includes the steps of providing a first substrate, evaporating a first layer comprising a reflective material on a portion of the first substrate, coating the substrate with a second layer comprising a material that is inert to an etchant, forming patterns through the second layer to provide a patterned coated substrate, submersing the pattern coated substrate in etchant to etch transmissive patterns into the first layer on the first substrate, and coupling the detector port with a photomultiplier tube having a sensor for measuring photon density from a photon source.

A third exemplary embodiment of the present invention includes a method of making a device for measuring photon density (mW/cm³) within an E-M field from a photon source. The method comprises providing a first substrate, partially submersing the substrate with a first layer comprising a UV-C transmitting coating containing UV-C blocking or reflecting particles, repeating the coating several times to various depths resulting in a total coating that provides decreasing blocking coverage from the top of the substrate, and coupling the detector port with a photomultiplier tube having a sensor for measuring photon density from a photon source.

A fourth exemplary embodiment of the present invention includes a method of making a device for measuring photon density (mW/cm³) within an E-M field from a photon source. The method comprises suspending nanoparticles having reflective properties in a UV-C transmissive adhesive coating. Next, the nanoparticles are applied to the substrate. In one configuration, the nanoparticles are applied by dipping the substrate into the UV-C transmissive adhesive coating having the nanoparticles. In one configuration, the method includes dipping the substrate into the UV-C transmissive adhesive coating at least twice. In one configuration, the nanoparticles are aluminum nanoparticles.

A fifth exemplary embodiment of the present invention includes a method of making a device for measuring photon density (mW/cm³) within an E-M field from a photon source. The method comprises providing a silicon wafer, depositing on the silicon wafer a sacrificial layer, depositing a photoresist layer on the wafer, submitting the wafer to a photolithographic process, exposing the wafer to the inverse of a petal-pattern, removing the sacrificial layer with a chemical bath, placing the substrate in contact with the pattern such that the pattern wraps around the substrate, and securing the substrate.

The following will describe embodiments of the present invention, but it should be appreciated that the present invention is not limited to the descried embodiments and various modifications of the invention are possible without departing from the basic principle. The scope of the present invention is therefore to be determined solely by the appended claims.

### BRIEF DESCRIPTION OF THE SEVERAL VIEWS OF THE DRAWING(S)

FIG. 1 is a side elevation view of an embodiment of a probe head of an optical probe for measuring photon density.

FIG. 2 is a side elevation view of the embodiment of the probe head of the optical probe for measuring photon density showing a reflective layer and a clear surface of a probe head.

FIG. 3 is a cross-sectional view of the probe head of the optical probe of FIG. 1 taken along lines 1-1.

FIG. 4 is a graph showing photocurrent response (uA) as a function of a latitude as embodied in FIG. 5.

FIG. 5 is a cross-sectional view of an embodiment of an optical probe testing device for measuring photon density showing two possible optical paths of the optical probe.

FIG. 6 is a cross-sectional view of the embodiment of the optical probe shown in FIG. 1 taken along lines 1-1 showing optical paths at a singular aperture of the optical probe.

FIG. 7 is side elevation of another embodiment of the optical probe for measuring photon density.

FIG. 8 is a perspective view the embodiment shown in FIG. 7, showing the optical paths at a singular aperture of the optical probe.

FIG. 9 is a side elevation view of the embodiment shown in FIG. 7 including a probe head, a light pipe, and tubing.

FIG. 10 is a perspective view of the embodiment shown in FIG. 7 including a probe head, a light pipe, and an extended tubing.

FIG. 11 is a perspective view of the embodiment of FIG. 7 showing the optical probe coupled to a detector.

FIG. 12 is a flow chart of a method of making the optical probe of FIG. 1 for measuring photon density (mW/cm³) within a medium from an optical radiation field.

FIG. 13 is a flow chart of a method of making the optical probe of FIG. 7 for measuring photon density (mW/cm³) within a medium from an optical radiation field.

FIG. 14 is a flow chart of a method of making the optical probe of FIG. 7 for measuring photon density (mW/cm³) within a medium from an optical radiation field.

FIG. 15A is a perspective view of an embodiment of the optical probe for measuring photon density (mW/cm³) using the particle distribution approach and representing a possible density and size of particles after a first application.

FIG. 15B is a perspective view of an embodiment of the optical probe for measuring photon density (mW/cm³) using the particle distribution approach and representing a possible density and size of particles after a second application.

FIG. 15C is a perspective view of an embodiment of the optical probe for measuring photon density (mW/cm³) using the particle distribution approach and representing a possible density and size of particles after a third application.

FIG. 15D is a perspective view of an embodiment of the optical probe for measuring photon density (mW/cm³) using the particle distribution approach and representing a possible density and size of particles after a fourth application.

FIG. 16 is a flow chart of a method of making the optical probe of FIG. 7 for measuring photon density (mW/cm³) within a medium from an optical radiation field.

### DETAILED DESCRIPTION OF THE INVENTION

It is to be understood that the invention may assume various alternative orientations and step sequences, except where expressly specified to the contrary. It is also to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

One skilled in the relevant art will recognize that the elements and techniques described herein can be practiced without one or more of the specific details, or with other methods, components, materials, etc. In some instances, well-known structures, materials, or operations are not shown or described in detail to avoid obscuring certain aspects of the present disclosure. Reference throughout the specification to “one embodiment” or “an embodiment” means that a particular feature, structure, or characteristic described in connection with the embodiment is included in at least one embodiment of the present disclosure. Thus, the appearance of the phrase “in one embodiment” or “in an embodiment” throughout the specification is not necessarily referring to the same embodiment. However, the particular features, structures, or characteristics described may be combined in any suitable manner in one or more embodiments.

Where they are used herein, the terms “first”, “second”, and so on, do not necessarily denote any ordinal, sequential, or priority relation, but are simply used to clearly distinguish one element or set of elements from another, unless specified otherwise.

Where used herein, the term “exemplary” is meant to be “an example of,” and is not intended to suggest any preferred or ideal embodiment.

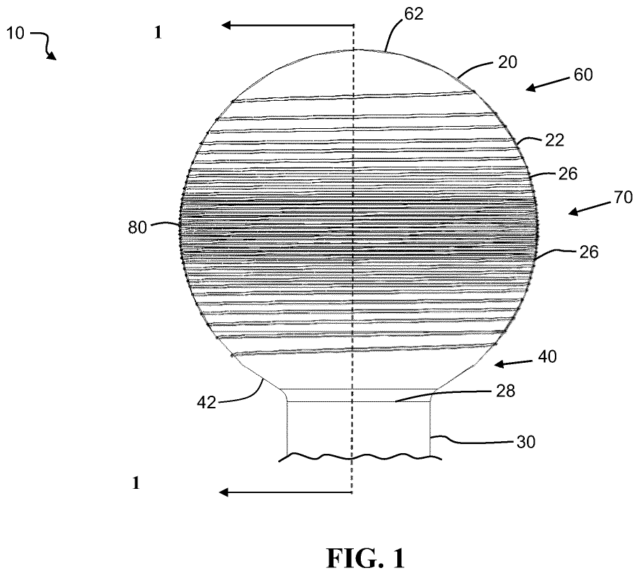

FIG. 1 is a side elevation view showing an embodiment of an optical probe 10 for measuring photon density.

The total electromagnetic energy contained within an optical radiation field (sometimes referred to as the detection field, is defined as Q measured in Joules. The energy density u is defined as the radiant energy dQ contained in a volume element dV

$$u = \frac{d Q}{d V} ( \frac{J}{{m}^{3}} )$$

or in the typical range of applications

$$( \frac{mJ}{c {m}^{3}} )$$

Taking the first derivative with respect to time provides us with the power density within the radiation field. We have defined this as the Photon Density

$$P = \frac{dQdt}{d V} ( \frac{W}{{m}^{3}} )$$

or in the typical range of applications

$$( \frac{mW}{c {m}^{3}} )$$

Photon density can also be described as Flux Capacitance

$${∅}_{c} ( \frac{1}{{cm}^{3}} )$$

of a device cavity multiplied by the source power within that cavity. More specifically, photon density is as follows:

$$Photon Density = Source flux * {\underbrace{( geometry - port - source factor ) * reflective gain}}_{Flux Capacitance {Φ}_{c} ( \frac{1}{c {m}^{3}} )} ( \frac{mW}{{cm}^{3}} )$$

The optical probe 10 may, for example, measure the photon density within a relatively small cavity cross section of a pathogen reduction system such as that described in U.S. Pat. No. 11,357,882 B2, titled METHOD, APPARATUS AND SYSTEM FOR REDUCING PATHOGENS IN A BREATHABLE AIRSTREAM IN AN ENVIRONMENT, which issued on Jun. 14, 2022, which is hereby incorporated by reference. Thus, the optical probe 10, in one configuration, is small enough to enter the chamber of such a pathogen reduction system and is able to accept light from many angles. A photon density measurement provides data that can be combined with pathogen particle velocities to establish Exposure values that can be used to compare pathogen reduction systems and predict and prove performance. Moreover, the optical probe 10 can be used within spaces where UV-C illumination is desired where there are occupants. That is, the optical probe 10 can be used to determine whether UV-C levels are sufficient for inactivation of pathogens and also to determine whether recommended limits on human exposure have been exceeded.

The optical probe 10 includes, in one configuration, a probe head 20 and a light pipe 30. The probe head 20 has an internal volume for receiving photons from within an optical radiation field (J/cm³), or stated differently, as described above, the total electromagnetic power contained within an optical radiation field is measured. In one configuration, the optical probe 10 is configured to measure a singular photon source. In another configuration, the optical probe 10 is configured to measure a plurality of photon sources. For example, the optical probe 10 may measure, in one configuration, an array of sources in a radiation field. In another configuration, the radiation field includes a plurality of sources as well as reflected light from those sources that act as additional sources. The optical probe 10 measures the photons passing through a point in space regardless of the directional path the photons take through that point in space. In some configurations, the photons are omnidirectional from within the optical radiation field. Light entering the probe head 20 diffracts and reflects inside the probe head 20 such that regardless of the direction the light is coming from, a substantially equal amount exits the probe head 20 and is transmitted, for example, through the light pipe, to be converted to an electrical signal.

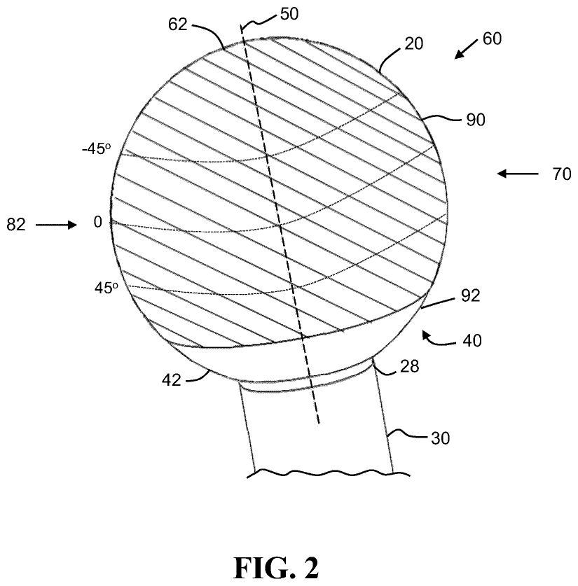

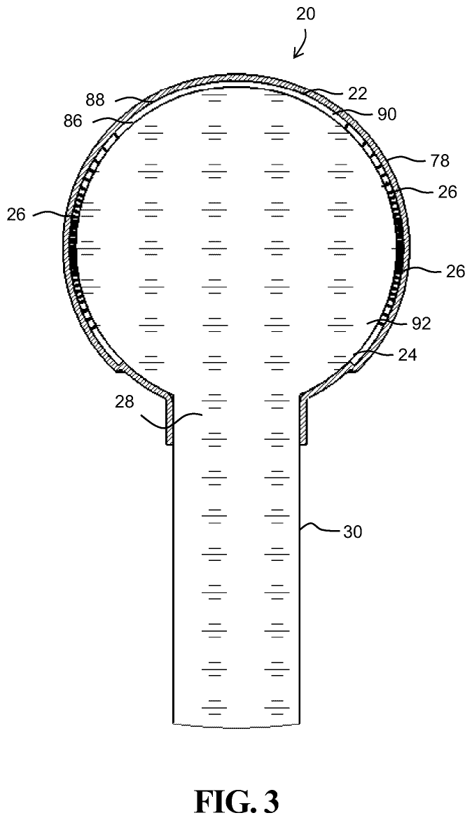

The probe head 20 includes an outer periphery 22, an inner periphery 24 and a plurality of entrance openings 26 within a reflective layer 90. Although the probe head 20 is shown as a spheroid it should be appreciated that other shapes having an inner volume are possible. For example, the probe head 20 may be a sphere, spheroid, oblate spheroid, prolate spheroid, or an ellipsoid. Typically, the probe head 20 will have rotational symmetry, however, it should be appreciated that alternate, non-spherical shapes may be utilized. The probe head 20 in one configuration is approximately 5 mm in diameter. In another configuration, the probe head 20 has a diameter ranging from between approximately 2 mm and approximately 8 mm. As described in more detail below, and shown in FIGS. 2 and 3, the probe head 20 includes the reflective layer 90, for example, an aluminum evaporate, covering a majority of the probe head 20. In one configuration, the reflective layer 90 coats approximately 50-90% of the substrate 92. In another configuration, the reflective layer 90 coats approximately 60-80% of the substrate 90. In a further configuration, the reflective layer 90 coats at least approximately 70% of the substrate 90. In yet another configuration, the reflective layer 90 coats the substrate 90 from the top 62 to approximately the +30 degree latitude of the probe head 20. In one configuration the reflective layer 90 is a mirror-like surface. In another configuration, the reflective layer 90 is specular where the incident angle equals the reflected angle. In yet another configuration, the reflective layer 90 provides diffuse reflectance wherein the light is reflected at many angles, also referred to as scattering.

Turning to FIGS. 2-3, the probe head 20 further includes an exit aperture 28. In one configuration, the probe head 20 and light pipe 30 comprise a substrate that is a solid fused silica or other material suitable for light transmission in the selected wavelength range of interest. In one configuration, the substrate is a solid fused silica for a selected wavelength in the UV-C range: 200-300 nm. However, other materials may be provided for the selected wavelength. As described in more detail below, a thermal aluminum evaporation method can form an aluminum layer on a substrate providing a reflective coating and providing a boundary between the outer periphery 22 and the inner periphery 24.

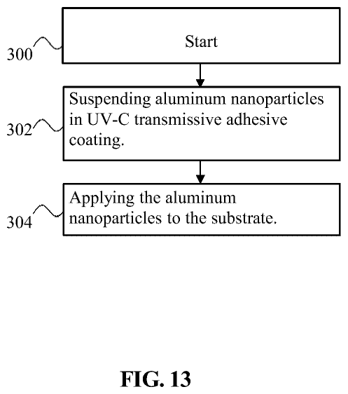

The outside surface of the aluminum layer on the outer periphery 22, is to provide a blocking layer for restricting light entry into the inner periphery 24. As described in more detail below, light is refracted through the substrate material and diffracted while entering the inner periphery 24 by way of the openings 26. This light is reflected off the inner periphery 24 surface of the aluminum layer creating an “integrating” effect such that the light exits the exit aperture 28 and is proportional to the light striking the outer periphery 22 regardless of position around the outer periphery 22. The optical probe 10 further includes a light pipe 30 coupled to the exit aperture 28. The light pipe 30 transmits the photons incident on the exit aperture 28 from the volume of the probe head 20 to a photon detector 94 (shown in FIG. 13). The photon detector 94 produces an electrical signal representative of the detected photon density. In a configuration, the light pipe shaft 30 exists from a lower region 40 of the probe head 20 and has an axis that is parallel to the optical axis 50.

In one configuration, the probe head 20 further comprises an upper region 60 opposite the exit aperture 28 and a middle region 70 between the lower region 40 and the upper region 60 and having a center that is equally distant from the poles of the probe head 20, sometimes referred to as an equator 80 shown as line 0° in FIG. 2 for illustrative purposes Similarly, latitude lines −45° and 45° are shown in FIG. 2 for illustrative purposes. As shown in FIG. 1, in one configuration, the plurality of entrance openings 26 comprise spiral openings or grooves having an increasing frequency and decreasing pitch near the middle region 70. By “pitch” it is meant to refer to the distance between opening 26 centers in the latitude direction. As discussed below, the openings 26 may alternatively be diffractive apertures, slits, or rings in the reflective portion of the probe head 20.

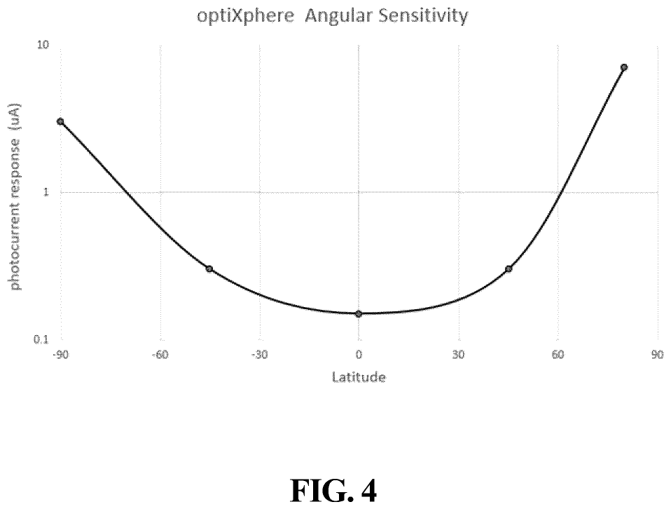

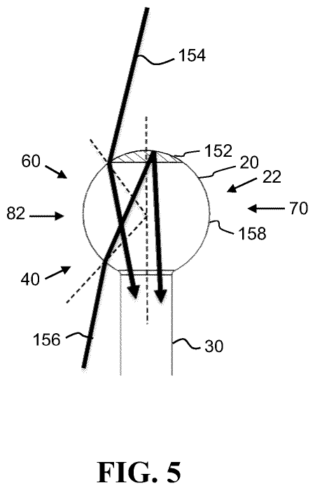

Turning to FIGS. 4 and 5, it should be understood that goniometric measurements of photomultiplier photocurrent response from the light pipe exit verses latitude angle provide that the on-axis response can be balanced with the response from light entering very close to the exit shaft. That is, the signal strength at the bottom (clear) region 42 (as shown in FIG. 2) is strong, and thus, the opening pattern at each latitude in the upper region 60 and middle region 70 is optimized to provide similarly strong signal strength.

To determine an optical probe configuration for providing an overall balance in signal, a test optical probe 150 as shown in FIG. 5 can be used. Here, the probe head 20 includes a reflective cap 152. In one configuration, the reflective cap 152 is an evaporate aluminum. FIG. 5 shows a light ray contributing to the signal from a source “on-axis” along with a ray contributing to the signal from a source at a high angle normal incident at a latitude of approximately 80°. Ray 154 is a component of an on-axis ray bundle that strikes the probe head 20 and is refracted at the surface. Ray 154 is directed down the exit light pipe 30. Ray 156 is part of a near light pipe 30 axis bundle that strikes the probe head 20 in the lower region 40 of the probe head 20 in the clear region 158 (area without the aluminum cap). This ray 156 is refracted upon entering the substrate and then reflected off the mirror-like surface cap and directed down the light pipe 30.

As shown in FIG. 4, showing the photocurrent response (uA) as a function of the angle from the detector (optical probe) 150 normal, the equator region 82 of the optical probe 150 received the lowest photocurrent response. Without diffractive elements, a significant portion of light entering the middle region passes completely through the probe head 20, never reaching the exit light pipe 30. Thus, diffractive elements on the probe head 20 as shown in FIGS. 1, 3 and 6 3, for example, are included, with the highest spatial frequency or largest number of diffractive elements per mm within the equator region 82, to diffract light into the upper region 60 to be reflected down into the exit pipe as well as diffracting light into the lower region 40 to be captured by the exit light pipe 30 directly. Stated differently, there is a varying degree of correction required—the use of a variable spatial frequency grating constructed generally along the latitude lines provides a tailored amount of diffraction to balance the overall detector response to within acceptable uniformity. In a configuration, the openings are thus, a varying spatial frequency spiral. Given that the equator has the lowest response it requires the highest diffractive effect which would occur with the highest spatial frequency or largest number of diffractive lines per mm.

As the angles increase starting from the middle region 70 towards the upper region 60 or lower region 40, the frequency of the openings 26 is reduced until reaching a near opaque region in a top portion 62 and an open substrate (clear) region in a bottom portion 42. While not a requirement, the shape of frequency variation of the openings 26 (grooves) can be symmetrical and somewhat “inverted” from the angular sensitivity curve shown in FIG. 4, where measurements were taken using a probe 150 having an aluminum cap 152 in the top region to block the straight through photons. The equator region 82 had the lowest photocurrent response and thus, vertical diffraction is needed to boost the signal response. Upward diffracted light has a chance to reflect down into the shaft and downward diffracted light has a chance to enter the shaft directly. The highest signal is generated from the lower region 40 near to the exit shaft 30, thus, openings 26, for example, spiral openings, or other diffractive components are needed to cover the middle region 70. As such, as shown in FIGS. 1, 2, and 3, an aluminum layer 90 extends to the lower region 40 of the probe head 20, wherein the remaining portion of the substrate 92 is clear providing the maximum signal from the lower region 42 region. Once aluminum is covering the substrate 92, diffractive openings 26 for boosting the equator region 82 signal can be created as well as openings 26 in the higher region since the refractive effect shown in FIG. 5 will be mostly gone. Typically, the top portion 62 has no openings since the signal strength would be the greatest here.

In the optical probe 10, all parameters of the functional shape are adjusted for optimization of the optical probe 10 response. For example, nonsymmetrical shapes of the openings 26 are expected and non-equal end points are anticipated. Variable inputs for the opening definition include the following: the start latitude (−SL) north pole is −90, the equator 0, and south pole +90; the start pitch (SP); the shape coefficients of how the pitch increases from here to the equator (a₁, b₁) if we assume a quadratic shape but it could be others or a look-up table with fit between values; the max pitch (MP) [equator]; the shape coefficients of how the pitch decreases from here to the equator (a₂, b₂) if we assume a quadratic shape but it could be others or a look-up table with fit between values; the end pitch (EP); the end latitude (+EL); and the lower Al boundary (LB).

As an example, in one configuration, the probe head 20 has the following parameters:

| Start of the spiral: | A latitude of −50 | |
|---|---|---|
| End of the spiral: | A latitude of 45 | |
| Lower boundary of the Al layer: | A latitude of 55 | |
| Width of the spiral opening: | 150 | nm |
| Start pitch: | 3000 | nm |
| Equator pitch: | 300 | nm |
| End pitch: | 1500 | nm |

Quadratic shape northern hemisphere: a1 = 0.54, b1 = −27, c1 = 300
Quadratic shape southern hemisphere: a2 = 0.3, b2 = 13, c2 = 300

It should be appreciated that quadratic shape is an example of one configuration of the probe head 20, but other shapes are possible. It should also be appreciated that, as pitch of the spiral groove entrance openings 26 is decreased, exposure of the clear substrate 92 increases. Therefore, transmission of light increases. An example of the variation of pitch with latitude across the area of the reflective layer 90 is shown in FIGS. 1-3, wherein the pitch at 0 degrees (the equator) is approximately 300 nm and the spiral opening is 150 nm, the pitch at 45 degrees latitude is approximately 1500 nm and the pitch at −50 degrees is approximately 3000 nm and the spiral opening is 150 nm. At the equator this means that 50% of the area is a clear opening and 50% is opaque, with an average transmission of 50%. When the pitch goes to 600 nm and the width stays the same, the transmission drops to 25%. By “transmission” it is meant the percentage of open area for light to be transmitted through the substrate 92. It is not intended to refer to a variation of diffraction but rather an intensity of the diffraction pattern.

In one configuration, the pitch verses latitude varies at a substantially constant slope. The spiral groove entrance openings 26 in one configuration are in the range between approximately −60 degrees and +60 degrees, or between approximately −50 degrees and +45 degrees or between approximately −45 degrees and +45 degrees.

In another configuration, the pitch variation verse latitude is a non-constant slope. Whether the pitch is substantially constant or non-constant, the transmission across the latitudes will provide the greatest transmission at 0 degrees.

In yet another configuration, the openings 26 are a plurality of bands. That is, each band has a constant, nonvarying pitch and each band is spaced from the other.

In a further configuration, the openings 26 have a constant pitch over a few degrees latitude and then a non-constant pitch. For example, between latitudes −50 degrees and −35 degrees, the pitch may be 3000 nm and then decrease to 2000 nm at −35 degrees latitude.

It should be appreciated that light coming from a point source anywhere in the optical radiation field will be incident on the full side of the probe head 22 creating a cone of light rays centered on the line between the source and the normal to the probe head 22. This provides an “area” averaging type effect which may result in angular sensitivity that is adequate for the desired level of calibration. The “field” is defined as the volume occupied by the probe head 20 due to the sum of point sources generating photons that pass through the volume of the substrate 92.

It should be appreciated that, in the embodiment shown in FIGS. 1 and 3, while the maximum frequency of openings is provided in the middle region 70 and typically at the equator 80, the maximum frequency of openings 26 may be above or below the equator 80 depending on the other variables of the system. Moreover, in another configuration, “bands” of constant frequency may provide an adequate detector response. These bands may optionally include a variable frequency. As shown in FIG. 1, in one configuration, the entrance openings 26 are formed of a spiral groove. By “spiral groove” it is meant that the openings 26 are a variable frequency diffraction grating of the transmission type. In another configuration, the entrance openings 26 are apertures, wherein the apertures are circular, non-circular, oval, elliptical, rectangular, square, polygonal, spiral, and/or slits. The entrance openings 26 allow light to enter from the outer periphery 22 to the inner periphery 24 of the substrate 92.

An additional consideration is the dimensional size of the openings 26. Diffractive angle varies for different wavelengths with respect to the width of the diffractive slit. Once the slit width has reached the wavelength of light the diffraction becomes independent of wavelength. In an embodiment where the goal is to measure UV-C light which falls in the range of 200 to 300 nm, the openings 26 should be 200 nm or less in width for the diffractive elements to behave the same for all wavelengths in the range. This narrow width, however, requires higher spatial frequencies to obtain enough light for balancing the photomultiplier photocurrent response from different regions of the probe head 20. In an embodiment configurated to measure visible light from 380 to 700 nm, then the diffractive elements need only be 380 nm maximum width and spatial frequencies could be reduced.

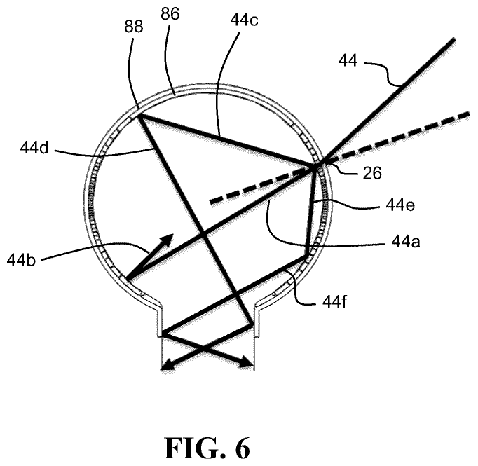

As shown in FIGS. 3 and 6, it should be understood that the reflective layer 90 has two sides: an inside reflective surface 86 and an outside reflective surface 88. The inside reflective surface 86 facilitates integration while the outside reflective surface 88 blocks light from entering the volume of the substrate 92 and assists in balancing the angular signal response. The substrate 92 has a protective coating 78, which, as described below, may be a UV-C transmissive protective coating.

As shown in FIG. 6, a light ray 44 is incident at an angle to normal and at a latitude of approximately −30°. Refracted ray 44a is refracted at the surface and then reflected off the mirror-like reflective surface 86 as ray 44b. Reflected ray 44b contributes to the integration component of the optical probe 10. Ray 44 is also diffracted as ray 44c and then reflected off the mirror-like reflective surface 86 as 44d and directed down the light pipe 30. Further ray 44 is diffracted as it enters the volume of the substrate 92 and reflects off the mirror like reflective surface 86 as ray 44d and directed down the light pipe 30.

The light entering the probe head 20 is transmitted to a detector 94 (shown in FIG. 11). In one configuration, the detector 94 is a photomultiplier tube. The photocathode within the photomultiplier tube is selected based on the wavelength range of the optical device 10 design. For UV-C detection, a typical choice is a cesium telluride Cs—Te photocathode which has wavelength sensitivity from 160 to 320 nm. An example of a photomultiplier tube for this range is the Hamamatsu Photomultiplier Tube R7154, generally termed a High Sensitivity Solar Blind Photomultiplier. An alternative is a solid state device (photodiode), for example, a GaN junction. A GaN junction can be smaller and cheaper, but is also less sensitive to light. A photon passing through the fused silica substrate 92 and then light pipe or air reaches the quartz vacuum tube envelope and strikes the photocathode releasing an electron from the surface. This electron is accelerated and strikes a secondary emission plate, called a dynode, releasing several electrons. The multiplication process is repeated for each of the stages within the tube resulting in a very large number of electrons that are collected at the final stage and pass out of the tube to be measured using a variety of methods. A common method is the use of a pico-ammeter which can measure very small electrical currents, often called a photocurrent. The photocurrent to optical power density conversion is used to calibrate the detection system and then subsequently provides accurate measurements of optical power density. The amplification is required due to the small amount of light that is collected with the detector. Photomultipliers are capable of counting singe photons. It should be appreciated that while solid state device detector sensitivities have been ever improving a large signal gain is required for this invention.

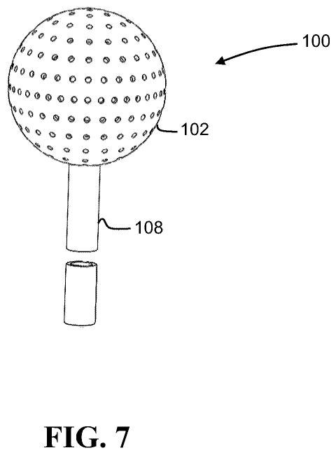

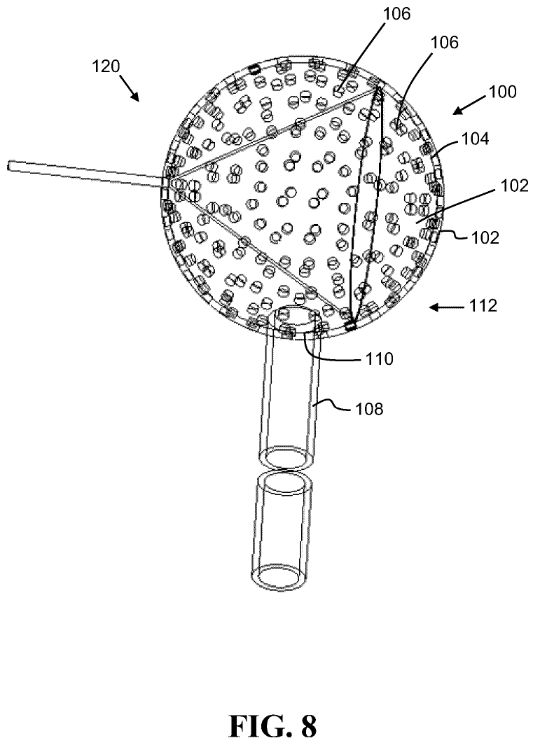

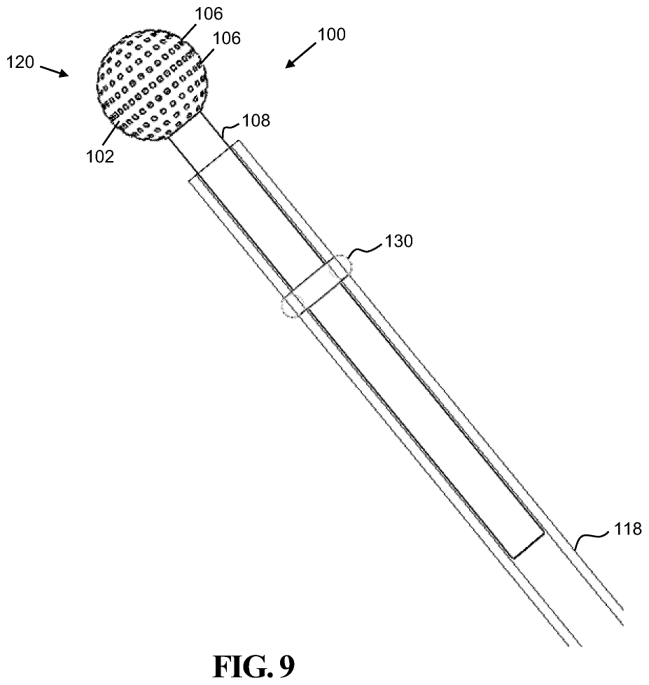

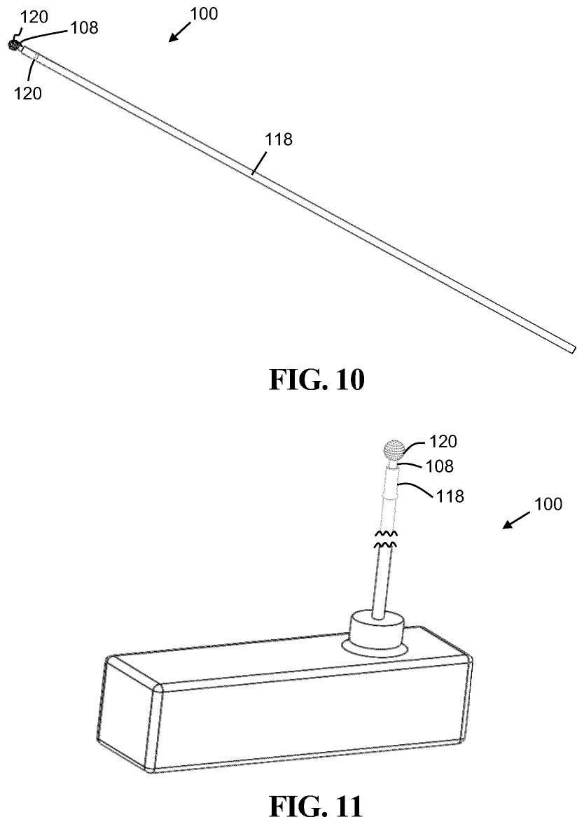

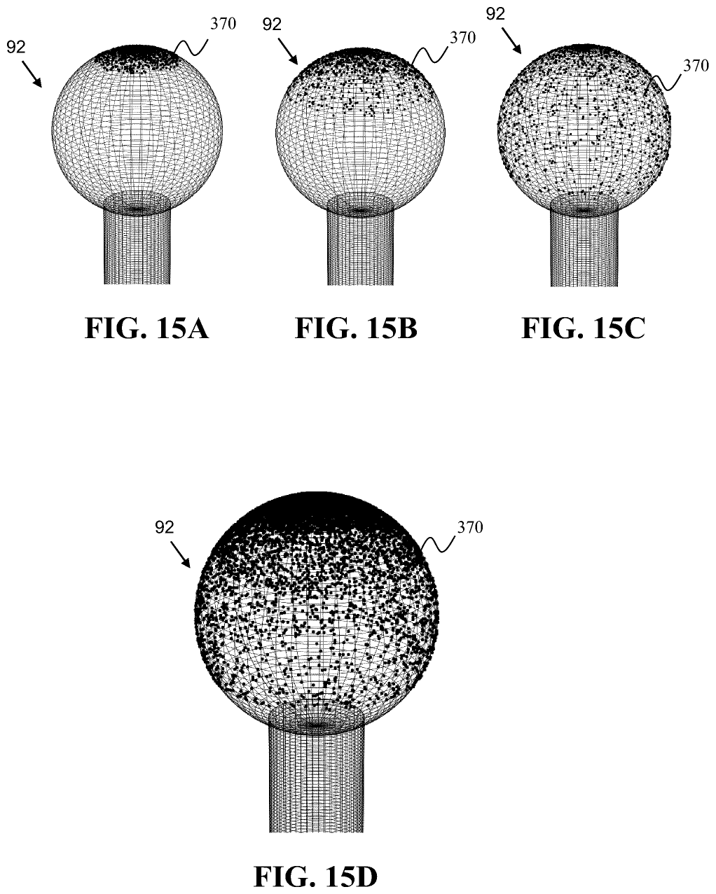

In another configuration, as shown in FIGS. 7-11, the optical probe 100 includes a substrate 102 having a reflective layer 104 forming a probe head 120. In one configuration the substrate 102 is made of quartz or fused silica and the reflective layer 104 is aluminum. The probe head 120 includes a plurality of entrance apertures 106. It should be appreciated that the number of apertures 106 is proportional to the accuracy of the signal. In one configuration, the apertures 106 provide a cone angle diffraction in the range between approximately 48° and 74°. The probe head 120 in one configuration is approximately 5 mm in diameter. In another configuration, the probe head 120 has a diameter ranging from between approximately 2 mm and approximately 8 mm. A light pipe 108 is coupled to an exit opening 110 at a lower region 112 of the probe head 120. In one configuration, the light pipe 108 is a quartz shaft which can be fused to the probe head 120. In one configuration, the light pipe 108 is 2 mm in diameter. A tubing 118 may be coupled to the light pipe 108 and a silicone o-ring 130 may be included on the tubing 118 to allow a depth to be selected. A variety of tubing lengths may be used. A longer tubing for reaching into an exposure chamber of a pathogen reduction system may be used. For example, in one configuration, the tubing 118 has a length to allow the probe head 120 to reach approximately ½ way into the illumination chamber of the pathogen reduction device. In another configuration, the tubing 118 has a length to allow the probe head 120 to reach between ¼ and ¾ into the illumination chamber of the pathogen reduction device. Thus, measurements of the photon density variations within the illumination chamber can be made, and the system performance can be determined. Alternatively, shorter tubing may be preferred for other environments. A photomultiplier tube 94, as described above, is coupled to the end of the tubing 118 and may be used to measure the photon density from the selected wavelength. In one configuration, the tubing 118 is made of aluminum. As shown in FIG. 8, the optical path at a singular aperture of the optical probe 10 is shown. First, UV-C rays are incident on an aperture 106. The light is diffracted, and may diffract in a diffraction cone patterns. The interior reflecting surface will direct the light to the output light pipe 108 for detection. The aperture pattern can be determined by a combination of a 3-D scan of the probe head 120, modeling and calculations. The probe head 120 can be placed in a goniometric fixture such that the nonuniformity of response with respect to incident angles and wavelength can be evaluated and adjustments made to refine the pattern composition. To protect and secure the aperture patterns coatings may be applied. These may be in the form of coatings or adhesives that transmit UV-C light. Exemplary coatings include, but are not limited to: (i) UV-Curable Epoxies: Certain UV-curable epoxies are formulated to be UV-C-transparent. They can be applied in a liquid form and then cured by exposure to UV light to form a solid bond. These adhesives are often used in optics and photonics applications; (ii) Optical Cements: Specialty optical cements can be used to bond glass or other optical materials with good transmission in the UV-C range. The composition of these adhesives is usually optimized for minimal absorption in the UV-C range; (iii) Silicone-Based Adhesives: Some silicone-based adhesives have been formulated for UV-C applications. Silicones tend to have better transmission in the UV range compared to many other polymers, and specialty formulations can further enhance this transmission; and (iv) Cyanoacrylates: Although regular cyanoacrylate adhesives (super glue) tend to absorb UV-C light, there are specialty formulations designed for optical applications that may have improved UV-C transmission. Additional coatings that are transparent in the UV-C (ultraviolet-C) region, which generally encompasses wavelengths from about 100 nm to 280 nm, can be used. Such coatings are useful in applications such as germicidal lamps, UV spectroscopy, and UV lithography. Exemplary additional coatings for UV-C transparency include the following: (i) Magnesium Fluoride (MgF2): This material is often used as a thin-film anti-reflection coating for UV-C applications. MgF2 is known for its excellent transmission properties in the UV-C region and is often used to reduce reflection losses at air-glass interfaces; (ii) Lanthanum Fluoride (LaF3): Similar to magnesium fluoride, lanthanum fluoride is another material used for anti-reflection coatings in the UV-C region. It can sometimes be used in combination with other materials in multilayer coatings optimized for specific wavelength ranges; (iii) Aluminum Oxide (Al2O3): Aluminum oxide thin films are sometimes used as protective coatings for UV-C applications, especially when chemical resistance is also required; (iv) Silicon Dioxide (SiO2): Silicon dioxide is often used in combination with other materials like magnesium fluoride to form multilayer anti-reflection coatings optimized for UV-C applications; and (v) Hafnium Oxide (HfO2): This material can be used in coatings to enhance damage thresholds, and in some cases, it may be incorporated into UV-C coatings. In one configuration, UV-C light blocking particles may be mixed with coating and the spaces between particles act as diffracting apertures instead of or in addition to apertures in the aluminum layer. Accordingly, a method is described below in FIG. 13 and a possible particle 370 distribution is shown in FIGS. 15A-15D and described below. If the particles 370 used also reflect UV-C light then a possible configuration would have no aluminum initial coating and the particles themselves act as the integrating surface on the periphery of the substrate.

With this configuration, the probe head 120 collects and integrates the photons and transfers them down the exit shaft 108 to a detector (PMT or Photodiode) where they are converted into a photocurrent that is proportional to the photon density. The rigid shaft 108 can exit into an aluminum tube 118. In another embodiment, a flexible quartz fiber is connected to the end of the rigid shaft 108, or alternatively, a flexible shaft is directly connected to the probe head 120.

### Method

As set forth above, a reflective layer 90 is coated onto the substrate 92. The deposition of the reflective layer 90 is controlled such that the reflective layer 90 can contribute in the balancing of the response. That is, partial transmission in conjunction with diffractive latitudinal lines combined may be employed for reaching the optimum response characteristic. The internal reflection provided by the reflective layer 90 allows the entering light to be reflected multiple times to provide a nearly uniform illumination on the inner periphery 24. The reflective layer 90 is useful by creating integrating type reflection of the light within the probe head 20. The outside reflections provided by the reflective layer 90 prevent light from getting in. Thus, both sides of the reflective layer 90 have a function. In one configuration, the reflective layer 90 is evaporated aluminum.

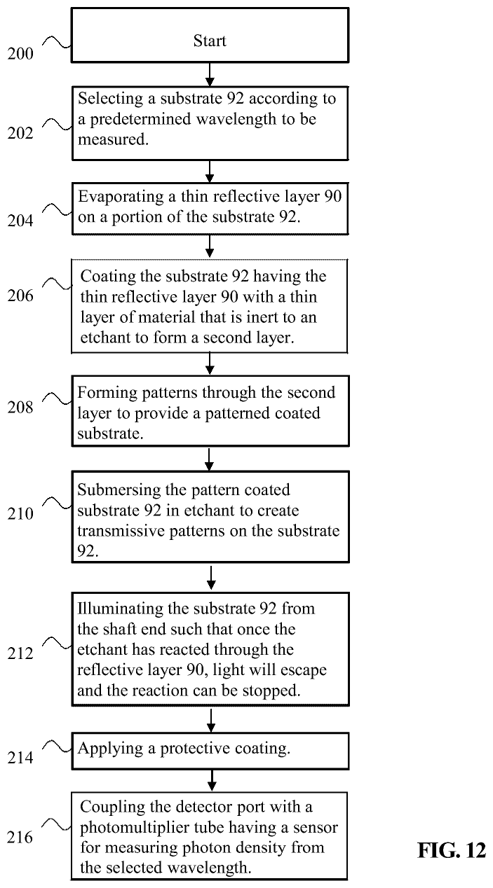

Turning to FIG. 12, in one configuration, a method of making the optical probe for measuring photon density (mW/cm³) within a medium from an optical radiation field 200 is provided. The first step 202 includes selecting a substrate 92 according to a predetermined wavelength to be measured. In one configuration, the substrate 92 is fused silica, however, other materials may be possible. The next step 204 includes evaporating a thin reflective layer 90 on a portion of the substrate 92. In one configuration, the thin reflective layer 90 is less than 20 nm in thickness. Aluminum at a thickness between 15 nm and 20 nm has a zero percent transmission of light. Next, according to step 206, the substrate with the thin reflective layer 90 is coated with a thin layer of material that is inert to an aluminum etchant to form a second layer 96. In one configuration, the coating is less than 2 micrometers in thickness. In a configuration, a paraffin wax is thinned with toluene solvent to provide a uniform thin coating. According to one method, the probe head 20 is removed from the paraffin wax and toluene solvent mixture by spin withdrawing the substrate from the bath. Using this technique, a coating between 1 and 2 micrometers can be obtained, and more preferably, less than 1 micrometer. Then, according to step 208, patterns are formed through the second layer to provide a patterned coated substrate. These patterns are sized and selected according to several inputs including wavelength to be measured and balancing the responses from various portions of the probe head 20, and may include any of the following shaped openings: circular, non-circular, oval, elliptical, rectangular, square, polygonal, spiral, and slits. In one configuration, the coated substrate is mounted in a machining center and nano-scaled tools (less than 100 nm) are used to form the patterns through the second layer 96 to provide the patterned coated substrate. In one configuration, atomic force microscope probes mounted in a machining center tool head are used to create the pattern within the wax layer. The atomic force microscope probe tips are, in one configuration, less than 15 nm. The next step 210 includes the step of submersing the pattern coated substrate 92 in etchant to create transmissive patterns on the substrate 92. According to step 212, to detect the appropriate time to stop the etchant reaction, the inside of the substrate 92 can be illuminated from the shaft end; once the etchant has reacted through the aluminum layer 90, light will escape and the reaction can be stopped.

Then, according to step 214, a protective coating is applied. In one configuration, the protective coating is a UV-C protective coating. An exemplary UV-C protective coating that can be used is MasterBond MB600 UV-C transparent coating. Exemplary coatings include, but are not limited to: (i) UV-Curable Epoxies: Certain UV-curable epoxies are formulated to be UV-C-transparent. They can be applied in a liquid form and then cured by exposure to UV light to form a solid bond. These adhesives are often used in optics and photonics applications; (ii) Optical Cements: Specialty optical cements can be used to bond glass or other optical materials with good transmission in the UV-C range. The composition of these adhesives is usually optimized for minimal absorption in the UV-C range; (iii) Silicone-Based Adhesives: Some silicone-based adhesives have been formulated for UV-C applications. Silicones tend to have better transmission in the UV range compared to many other polymers, and specialty formulations can further enhance this transmission; and (iv) Cyanoacrylates: Although regular cyanoacrylate adhesives (super glue) tend to absorb UV-C light, there are specialty formulations designed for optical applications that may have improved UV-C transmission. When selecting a UV-C transparent coating, it's important to consider not only the transmission properties but also other factors like the angle of incidence of the light, the polarization, the substrate material, and environmental factors like temperature and humidity that might affect the coating's performance.

Additional coatings that are transparent in the UV-C (ultraviolet-C) region, which generally encompasses wavelengths from about 100 nm to 280 nm, can be used. Such coatings are useful in applications such as germicidal lamps, UV spectroscopy, and UV lithography. Exemplary additional coatings for UV-C transparency include the following: (i) Magnesium Fluoride (MgF2): This material is often used as a thin-film anti-reflection coating for UV-C applications. MgF2 is known for its excellent transmission properties in the UV-C region and is often used to reduce reflection losses at air-glass interfaces; (ii) Lanthanum Fluoride (LaF3): Similar to magnesium fluoride, lanthanum fluoride is another material used for anti-reflection coatings in the UV-C region. It can sometimes be used in combination with other materials in multilayer coatings optimized for specific wavelength ranges; (iii) Aluminum Oxide (Al2O3): Aluminum oxide thin films are sometimes used as protective coatings for UV-C applications, especially when chemical resistance is also required; (iv) Silicon Dioxide (SiO2): Silicon dioxide is often used in combination with other materials like magnesium fluoride to form multilayer anti-reflection coatings optimized for UV-C applications; and (v) Hafnium Oxide (HfO2): This material can be used in coatings to enhance damage thresholds, and in some cases, it may be incorporated into UV-C coatings. In one configuration, UV-C light blocking particles may be mixed with coating and the spaces between particles act as diffracting apertures instead of or in addition to apertures in the Aluminum layer. If the particles used also reflect UV-C light then a possible configuration would have no Al initial coating and the particles themselves act as the integrating surface on the periphery of the substrate.

Then, according to step 216, the tubing 118, also referred to as a detector port, is coupled with a photomultiplier tube having a sensor for measuring photon density from the selected wavelength range of interest.

As set forth above, as provided in FIGS. 7 and 8 a reflective layer 104 is formed onto the substrate 102. The deposition of the reflective layer 102 is controlled such that the reflective layer can contribute in the balancing of the response. That is, partial transmission in conjunction with diffractive latitudinal lines combined may be employed for reaching the optimum response characteristic. The internal reflection provided by the reflective layer 104 allows the entering light to be reflected multiple times to provide a nearly uniform illumination on the inner periphery 124 of the probe head 120. The reflective layer 104 is useful by creating integrating type reflection of the light within the probe head 120. The outside reflections provided by the reflective layer 102 prevent light from getting in. Thus, both sides of the reflective layer 102 have a function. In one configuration, the reflective layer 104 is evaporated aluminum.

Turning to FIG. 13, in a configuration, a method of making the optical probe 100 for measuring photon density (mW/cm³) within a medium from an optical radiation field according to step 300 is provided. As a first step 302, aluminum nanoparticles 310 such as those available from nanoComposix, are suspended in a UV-C transmissive adhesive coating such as Masterbond MB600 UV-C transparent coating and applied to the quartz substrate 102 according to step 304. In a very thin layer near the “lower” region a single thickness of particles would have the maximum transmission. Spacing between the particles becomes the “apertures” diffracting incoming light. As shown in FIGS. 15A-15D, the thickness of the coating increases each time the upper region of the substrate is dipped into the suspension resulting in many layers of particles that would reduce the overall transmission a create multiple diffractive aperture paths. That is, FIGS. 15A-15D show an illustration of a representation of the density and size of particles 370 (not to scale) each time the substrate 92 is dipped into the suspension. FIG. 15 is a representation of the layer thickness after the first application/dip. FIG. 15B is a representation of the layer thickness after the second application/dip. The layer thickness of the aluminum nanoparticles 370 increases after each application/dip. Typically, the top of the substrate 92 has the highest thickness and particle density. In this example, the top:equator thickness ratio would be 3:1. Number of dips, particle concentrations, and the extent of dips can be varied to achieve the desired thickness and ratios. Once inside, total internal reflection along with light reflecting back into the probe head 120 from the highly reflective particles creates the integration effect. Nano particles can be made spherical, as cubes, triangular prisms, and wires as examples. Alternatively, a varying density of particles can be provided such that the density at the top would exceed the density in the lower regions. In one configuration, the coating is applied by 3-D nano printing of the adhesive-particle mixture directly onto the substrate. In another configuration, the coating is applied by 3D-printing onto a water surface and then bringing the quartz substrate 102 up through from underneath to apply the variable thickness coating. Another option includes repeated dips of the substrate 102 into the coating particle mixture going a bit deeper on each pass as shown in FIGS. 15A-15D. This would create a variable thickness layer.

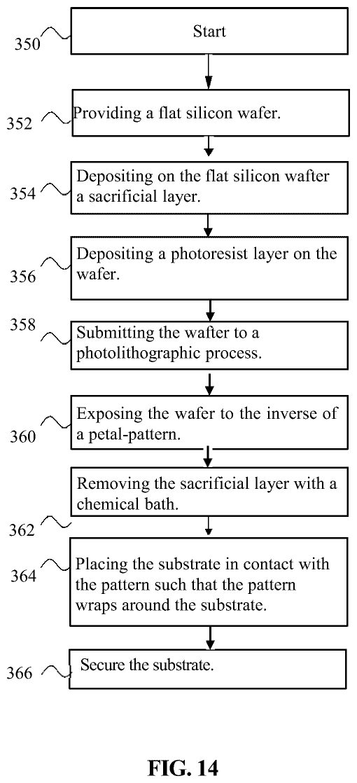

As shown in FIG. 14, another method of making the optical probe 100 for measuring photon density (mW/cm³) within a medium from an optical radiation field according to step 350 is provided as follows. First, according to step 352, a flat silicon wafer is provided. Then, according to step 354, a deposit is made on the flat silicon wafer as the a “sacrificial” layer. For example, an aluminum layer is deposited by evaporation. Next, according to step 356, a photoresist layer is deposited on the wafer. Then, the wafer is submitted to a photolithographic process according to step 358 and the wafer is exposed to the inverse of a petal-pattern according to step 360. A chemical bath removes the sacrificial layer according to step 362 leaving the aluminum pattern floating on the top. Then, according to step 364, from within the bath, the substrate 102 is placed in contact with the pattern, and the pattern wraps around the substrate 102. The wrap is then secured to the substrate 102 according to step 366. The wrap (aluminum layer) is highly reflective and coats the outside of the probe head 120 but acts as an internal reflective surface optically.

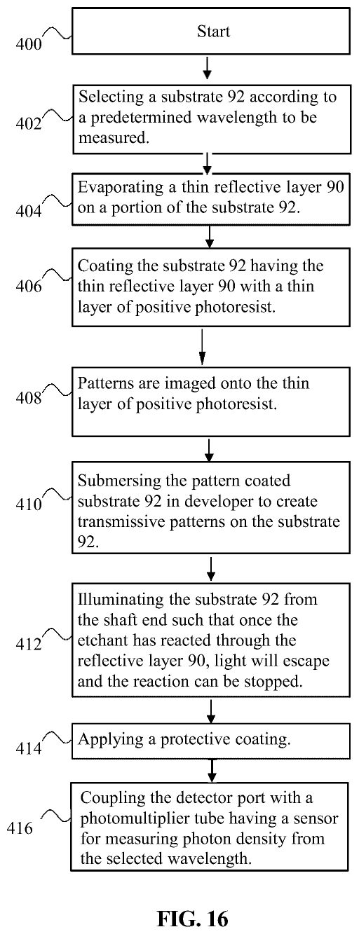

Turning now to FIG. 16, it should be appreciated that another method of making the optical probe for measuring photon density (mW/cm³) within a medium from an optical radiation field according to method 400 is provided. The method may be a mechanical lithographic method or a photolithographic method. The first step 402 includes selecting a substrate 92 according to a predetermined wavelength to be measured. In one configuration, the substrate 92 is fused silica, however, other materials may be possible. The next step 404 includes evaporating a thin reflective layer 90 on a portion of the substrate 92. In one configuration, the thin reflective layer 90 is less than 20 nm in thickness. Aluminum at a thickness between 15 nm and 20 nm has a zero percent transmission of light. Next, according to step 406, the substrate with the thin reflective layer 90 is coated with a thin layer of positive photoresist to form a second layer 96. In one configuration, the coating is less than 2 micrometers in thickness. In a configuration, a paraffin wax is thinned with toluene solvent to provide a uniform thin coating. According to one method, the probe head 20 is removed from the paraffin wax and toluene solvent mixture by spin withdrawing the substrate form the bath. Using this technique, a coating between 1 and 2 micrometers can be obtained, and more preferably, less than 1 micrometer. In the mechanical lithographic approach patterns through the wax are created using nanomachining methods. Alternatively a photoresist coating is applied and then, according to step 408, patterns are imaged onto the second layer to provide an exposure patterned coated substrate. In this photolithographic approach these patterns will become the openings 26 through the reflective layer and thus are sized and selected according to several inputs including wavelength to be measured and balancing the responses from various portions of the probe head 20, and may include any of the following shaped openings: a spot array, a slot array, a horizontal grating spot, or openings that are circular, non-circular, oval, elliptical, rectangular, square, polygonal, spiral, and slits. The next step 410 includes submersing the pattern coated substrate 92 in developer and/or etchant to create transmissive patterns on the substrate 92. Optionally, according to step 412, to detect the appropriate time to stop the etchant reaction, the inside of the substrate 92 can be illuminated from the shaft end; once the etchant has reacted through the aluminum layer 90, light will escape and the reaction can be stopped.

Then, according to step 414, a protective coating is applied as provided above with respect to method 200. Then, according to step 416, the tubing 118, also referred to as a detector port, is coupled with a photomultiplier tube having a sensor for measuring photon density from the selected wavelength range of interest.

The optical probe 10 operates in the optical part of the electromagnetic spectrum which is divided into three main regions and is limited by the range of wavelengths that can be manipulated by optical instruments such as lenses and mirrors. The regions are:
Visible light from about 400 nm to 700 nm.
Near-Infrared from 700 nm to about 2500 nm and
Ultraviolet light from 10 nm to 400 nm note: sub 200 nm light is absorbed in air so only useful in vacuum systems.

The configuration of the detector 94 is based in part on the range of wavelengths of interest. Typical, the optical probe 10 provides that the diffraction angle is the same for all the wavelengths of interest. The diffraction angle max occurs when the opening width is equal to or less than the lowest wavelength in the region of interest. For example, if the region of interest was visible light, then an opening width of 400 nm would produce the same diffractive effect over the full range from 400 to 700 nm. In certain embodiments, the diffractive features are approximately 500 nm, which would provide calculations for the effects of diffraction that would be variable based on wavelengths. If the optical probe 10 is configured for a visible light application, then a feature width of 400 nm would provide uniform diffractive effect though the region of interest.

One or more features of the embodiments described herein may be combined to create additional embodiments which are not depicted. While various embodiments have been described in detail above, it should be understood that they have been presented by way of example, and not limitation. It will be apparent to persons skilled in the relevant arts that the disclosed subject matter may be embodied in other specific forms, variations, and modifications without departing from the scope, spirit, or essential characteristics thereof.

The embodiments described above are therefore to be considered in all respects as illustrative, and not restrictive. The scope of the invention is indicated by the appended claims, and all changes that come within the meaning and range of equivalents thereof are intended to be embraced therein.

1. An apparatus for measuring photon density (mW/cm³) within a medium, the apparatus comprising:
a substrate having a volume for receiving photons from within an optical radiation field (J/cm³), the substrate having (i) an outer periphery; (ii) an inner periphery; and (iii) an exit aperture;
a first reflecting layer coating at least a portion of the outer periphery of the substrate, the first reflective layer configured to integrate the photons within the volume of the substrate;
a plurality of entrance openings within the first reflective layer for diffracting the photons entering the volume; and
a photon detector configured to receive the photons to detect a photon density and to produce an electrical signal representative of the detected photon density, wherein the substrate having the coating is configured such that the photons incident on the exit aperture of the volume of the substrate are at least substantially equally proportional to the photons incident on the plurality of entrance openings.

2. The apparatus of claim 1, wherein the first reflecting layer coats at least approximately 70% of the substrate.

3. The apparatus of claim 2, wherein the substrate has an optical axis and includes a lower region near the exit aperture, an upper region opposite the exit aperture, and a middle region between the lower region and the upper region and having an equator, and wherein the plurality of entrance openings comprises spiral openings having an increasing frequency and decreasing pitch near the middle region.

4. The apparatus of claim 3, wherein the spiral openings along the lower region and the upper region each have a symmetrical frequency and an inversely symmetrical pitch.

5. The apparatus of claim 1, wherein the substrate is substantially spherical and wherein the plurality of entrance openings are apertures having a nonuniform distribution on the substrate, wherein a number of apertures increase as the location on the substrate nears the equator.

6. The apparatus of claim 1, wherein at least one source producing light within the optical radiation field has a range of wavelengths in the range of between approximately 200 nm and 400 nm.

7. The apparatus of claim 1, wherein at least one source producing light within the optical radiation field has a range of wavelengths in the range of between approximately 400 nm and 700 nm.

8. The apparatus of claim 1, wherein at least one source producing light within the optical radiation field has a range of wavelengths in the range of between approximately 700 nm and 2500 nm.

9. The apparatus of claim 1, wherein at least one source producing light within the optical radiation field has a range of wavelengths in the range of between approximately 10 nm and 400 nm.

10. The apparatus of claim 5, wherein the plurality of apertures have the same diameter of approximately 0.5 micrometers and provide a cone angle diffraction in the range between approximately 48° and 74°.

11. The apparatus of claim 2, wherein the shape of the plurality of entrance openings is selected from a group consisting of one of circular, non-circular, oval, elliptical, rectangular, square, polygonal, spiral, and slits.

12. The apparatus of claim 1, wherein the plurality of entrance openings have a width that corresponds to the minimum wavelength within a range of wavelengths of interest within the optical radiation field.

13. The apparatus of claim 3, wherein the first reflecting layer extends from the optical axis of the substrate towards the lower region of the substrate and includes an outer surface and an inner surface, wherein the inner surface is opaque and, highly reflective.

14. The optical probe of claim 1, further comprising a light pipe coupled to the exit aperture to carry the photons incident on the exit aperture from the volume of the substrate to a photon detector, wherein the photon detector and the light pipe are configured to carry the photons incident on the exit aperture from the volume of the substrate to the photon detector.

15. The apparatus of claim 14, wherein the substrate is substantially spherical and includes an equator within the middle region, and wherein the light pipe is perpendicular to the equator of the substantially spherical substrate.

16. A method of making a device for measuring photon density (mW/cm³) within an E-M field from a photon source, the method comprising:
a. providing a first substrate;
b. evaporating a first layer comprising a reflective material on a portion of the first substrate;
c. coating the substrate with a second layer comprising a material that is inert to an etchant;
d. forming patterns through the second layer to provide a patterned coated substrate;
e. submersing the pattern coated substrate in etchant to etch transmissive patterns into the first layer on the first substrate;
f. coupling the detector port with a photomultiplier tube having a sensor for measuring photon density from a photon source.

17. The method of claim 16, wherein the first layer is aluminum and is less than 20 nm in thickness and wherein the etchant is an aluminum etchant.

18. The method of claim 16, further comprising the step of applying a protective UV-C transmitting coating after submersing the pattern coated substrate in etchant.

19. The method of claim 16, wherein the second layer is a paraffin wax and is less than 2 micrometers in thickness.

20. The method of claim 16, wherein the step of forming patterns to provide a patterned coated substrate further comprises the step of mounting the coated substrate in a machining center and utilizing nano-scaled tools to form the patterns through the second layer to provide the patterned coated substrate.

21. The method of claim 16, further comprising the step of coupling a light pipe between an exit aperture of the first substrate and the photomultiplier tube.

22. The method of claim 16, wherein the step of providing a first substrate includes the step of providing a solid fused silica substrate.

23. The method of claim 16, further comprising the step of correlating width of the transmissive patterns on the substrate with the minimum wavelength of the E-M field.

24. The method of claim 16, wherein the transmissive patterns etched into the first layer are selected from a group consisting of one of circular, non-circular, oval, elliptical, rectangular, square, polygonal, spiral, bands, and slits.
